(19) United States
(12) Patent Application Publication
(10) Pub. No.: US 2024/0395476 A1
(43) Pub. Date: Nov. 28, 2024

(54) CIRCUIT BREAKER AND METHOD

(71) Applicant: Siemens Aktiengesellschaft, München (DE)

(72) Inventors: Marvin Tannhäuser, Hausen (DE); Manfred Heindl, Alteglofsheim (DE); Jörg Hussmann, Neumarkt (DE)

(21) Appl. No.: 18/696,463

(22) PCT Filed: Sep. 12, 2022
(86) PCT No.: PCT/EP2022/075277

§ 371 Date: Mar. 28, 2024

(30) Foreign Application Priority Data
Sep. 28, 2021 (DE) 10 2021 210 824.5

(51) Int. Cl. H01H 9/54; H01H 71/04; H01H 83/10; H01H 83/12; H01H 83/14; H01H 83/20

(52) U.S. Cl. CPC H01H 9/547; H01H 9/548; H01H 71/04; H01H 83/14; H01H 83/20; H01H 2071/044; H01H 83/10; H01H 83/12

(57) ABSTRACT

A circuit breaker protects an electric low-voltage circuit, and has the function of ascertaining a level of the current of the low-voltage circuit. A mechanical separating contact unit is operated using a mechanical handle such that an opening function of contacts is switched to prevent a current flow or a closing function of the contacts is switched for a current flow in the low-voltage circuit. An electronic interruption unit is connected to the mechanical separating contact unit in series on the circuit side and which, as a result of semiconductor-based switch elements, has a high-ohmic state of the switch elements to prevent a current flow and a low-ohmic state of the switch elements for a current flow in the low-voltage circuit. The ascertained current level is compared with current thresholds and if the current thresholds are exceeded, a process for preventing the current flow in the low-voltage circuit is initiated.

The invention relates to the technical field of a circuit breaker device for a low-voltage circuit having an electronic interruption unit as per the preamble of patent claim 1 and to a method for a circuit breaker device for a low-voltage circuit having an electronic interruption unit as per the preamble of patent claim 14.

Low voltage means voltages of up to 1000 volts AC or up to volts DC. Low voltage means in particular voltages that are greater than the extra-low voltage, with values of 50 volts AC or 120 volts DC.

Low-voltage circuit or network or system means circuits having nominal currents or rated currents of up to 125 amps, more specifically up to 63 amps. Low-voltage circuit means in particular circuits having nominal currents or rated currents of up to 50 amps, 40 amps, 32 amps, 25 amps, 16 amps or 10 amps. The stated current values mean in particular nominal, rated or/and switch-off currents, i.e. the maximum current normally carried via the circuit or usually resulting in the electrical circuit being interrupted, for example by a protection device, such as a circuit breaker device, miniature circuit breaker or power breaker.

Miniature circuit breakers are overcurrent protection devices that have been known for a long time and are employed in low-voltage circuits in electrical installation engineering. They protect lines from damage as a result of heating due to excessively high current and/or short circuit. A miniature circuit breaker can automatically break the circuit in the event of overload and/or short circuit. A miniature circuit breaker is a fusing element that does not automatically reset.

Power breakers, in contrast to miniature circuit breakers, are provided for currents greater than 125 A, in some cases even from as little as 63 amps. Miniature circuit breakers are therefore of simpler and more delicate design. Miniature circuit breakers normally have a mounting option for mounting on what is known as a top-hat rail (mounting rail, DIN rail, TH35).

Miniature circuit breakers are of electromechanical design. They have a mechanical switching contact or open-circuit shunt release in a housing in order to interrupt (trip) the electric current. A bimetallic protection element or bimetallic element is normally used for tripping (interruption) in the event of longer-lasting overcurrent (overcurrent protection) or in the event of thermal overload (overload protection). An electromagnetic trip with a coil is employed for brief tripping when an overcurrent limit value is exceeded or in the event of a short circuit (short circuit protection). One or more arc extinguishing chamber(s) or devices for arc extinction are provided. In addition, connecting elements for conductors of the electrical circuit that is to be protected.

Circuit breaker devices having an electronic interruption unit are relatively novel developments. They have a semiconductor-based electronic interruption unit. That is to say that the flow of electric current in the low-voltage circuit is carried via semiconductor components or semiconductor switches that are able to interrupt the flow of electric current or to be switched on. Circuit breaker devices having an electronic interruption unit also frequently have a mechanical isolating contact system, in particular having isolator properties according to relevant standards for low-voltage circuits, the contacts of the mechanical isolating contact system being connected in series with the electronic interruption unit, i.e. the current in the low-voltage circuit to be protected is carried via both the mechanical isolating contact system and the electronic interruption unit.

The present invention in particular relates to low-voltage AC circuits, having an AC voltage, normally having a time-dependent sinusoidal AC voltage at the frequency f. The time dependency of the instantaneous voltage value u(t) of the AC voltage is described by the equation:

$$u ( t ) = U * sin ( 2 π * f * t ) ,$$

where:
u(t)=instantaneous voltage value at the time t
U=amplitude of the voltage

A harmonic AC voltage can be represented by the rotation of a vector, the length of which corresponds to the amplitude (U) of the voltage. The instantaneous deflection is the projection of the vector onto a coordinate system. One oscillation period corresponds to one full revolution of the vector, and the full angle thereof is 2π (2 pi) or 360°. The angular frequency is the rate of change of the phase angle of this rotating vector. The angular frequency of a harmonic oscillation is always 2π times its frequency, i.e.:

$$ω = 2 π * f = 2 π / T = angular frequency of the AC voltage$$

(T=period duration of the oscillation)

The indication of angular frequency (w) is often preferred over frequency (f), since many formulae in oscillation theory can be represented more compactly using angular frequency on account of the occurrence of trigonometric functions, the period of which is by definition 2π:

$$u ( t ) = U * sin ( ω t )$$

The term instantaneous angular frequency is also used in the case of angular frequencies that are not constant over time.

In the case of a sinusoidal AC voltage, in particular one that is constant over time, the time-dependent value comprising the angular velocity ω and the time t corresponds to the time-dependent angle φ(t), which is also referred to as the phase angle φ(t). That is to say that the phase angle φ(t) periodically passes through the range 0 . . . 2π, or 0° . . . 360°. That is to say that the phase angle periodically assumes a value between 0 and 2n, or 0° and 360° (φ=n*(0 . . . 2π), or φ=n*(0° . . . 360°), due to periodicity; in short: φ=0 . . . 2π, or φ=0° . . . 360°).

Instantaneous voltage value u(t) therefore means the instantaneous value of the voltage at the time t, i.e. for a sinusoidal (periodic) AC voltage the value of the voltage at the phase angle φ (φ=0 . . . 2π, or φ=0° . . . 360°, of the respective period).

The object of the present invention is to improve a circuit breaker device of the type mentioned at the outset, in particular to improve the safety of such a circuit breaker device or to provide a novel concept for such a circuit breaker device.

This object is achieved by a circuit breaker device having the features of patent claim 1 and by a method as claimed in patent claim 14.

According to the invention, provision is made for a circuit breaker device for protecting an electrical low-voltage circuit, in particular a low-voltage AC circuit, comprising:
a housing having network-side and load-side connections for conductors of the low-voltage circuit,
in particular a (first) voltage sensor unit for ascertaining the level of the voltage of the low-voltage circuit,
a current sensor unit for ascertaining the level of the current of the low-voltage circuit,
a mechanical isolating contact unit which is able to be switched and able to be operated using a mechanical handle, with the result that opening of contacts in order to prevent a current flow or closing of the contacts for a current flow in the low-voltage circuit is able to be switched (using the handle), so that (in particular) electrical isolation in the low-voltage circuit is able to be switched;
in the case of a mechanical isolating contact unit, opening of contacts is also referred to as disconnection, and closing of contacts is referred to as connection;
an electronic interruption unit which is connected in series with the mechanical isolating contact unit on the circuit side and which, as a result of semiconductor-based switching elements, has a high-impedance (in particular non-conductive) state of the switching elements in order to prevent a current flow and a low-impedance (conductive) state of the switching elements for the current flow in the low-voltage circuit;
in the case of an electronic interruption unit, a high-impedance (in particular non-conductive) state of the switching elements (for preventing a current flow) is also referred to as a switched-off state (process: switching off) and a low-impedance (conductive) state of the switching elements (for the current flow) is referred to as a switched-on state (process: switching on);
a control unit which is connected to the (first) voltage sensor unit, to the current sensor unit, to the mechanical isolating contact unit and to the electronic interruption unit, wherein if current limit values or current-time limit values are exceeded (i.e. if a current limit value is exceeded for a particular period of time) a process for preventing a current flow in the low-voltage circuit is initiated, in particular in order to prevent a short-circuit current.

According to the invention, the circuit breaker device is configured in such a way that a user of the circuit breaker device operates the mechanical handle (for a switching-on process) in order to close the contacts (connection process), wherein the electronic interruption unit is high-impedance. After the contacts have been closed, the electronic interruption unit becomes low-impedance only if a checking function allows a low-impedance state of the switching elements (switching-on process completed).

This has the particular advantage that a current flow occurs or is allowed only if a checking function of the circuit breaker device allows a low-impedance state. Thus, on the one hand, increased operational safety is achieved, wherein, for example, a device having defective protective functions, in the case of which the checking function does not allow a low-impedance state, does not switch on as a current-carrying device undertaking protective functions in the circuit.

On the other hand, a completely novel operating concept is introduced, in which although a user of the circuit breaker device is able to connect said circuit breaker device (i.e. use the mechanical handle to close the contacts of the mechanical isolating contact unit) they are not able to switch it on (no low-impedance state of the switching elements of the electronic interruption unit). Switching on is performed exclusively by the circuit breaker device itself. Switching on of the circuit breaker device, i.e. a current flow in the low-voltage circuit, cannot be forced by the user. In particular, switching on of the circuit breaker device—even in the fault-free state of the circuit breaker device or in the fault-free case of the low-voltage circuit (e.g. no short circuit)—cannot be forced by the user.

According to the invention, the circuit breaker device therefore contains two switching units: a mechanical isolating contact unit (switching unit) and an electronic interruption unit (switching unit), wherein
the mechanical isolating contact unit comprises (carries out/undertakes) the function for (electrical) connection and disconnection, and
the electronic interruption unit comprises (carries out/undertakes) the function for respectively switching the current or the voltage on and off.

In particular, the mechanical isolating contact unit is only able to be operated using the mechanical handle. The switching on and off by means of the electronic interruption unit is not able to be operated (directly) on the device.

Advantageous configurations of the invention are specified in the dependent claims and in the exemplary embodiment.

In one advantageous configuration of the invention, a display unit for displaying information is provided on the circuit breaker device and is connected to the control unit (SE).

The display unit displays in particular states of the circuit breaker device.

The information display displays in particular the state of the switching elements of the electronic interruption unit. Furthermore, the position of the contacts of the mechanical isolating contact unit can in particular be displayed.

This has the particular advantage that a user can see the state of the circuit breaker device quickly, in particular the state of the electronic interruption unit.

In one advantageous configuration of the invention, the checking function comprises a self-test of the functionality of the circuit breaker device,
during which at least one component, in particular a plurality of components,
of a unit, in particular of a plurality of units,
of the circuit breaker device is (are) checked,
and if the at least one component, in particular the plurality of components,
of a unit, in particular of a plurality of units,
is/are functional, the low-impedance state (of the electronic interruption unit) is allowed.

For example, a self-test of the functionality of at least one component of a unit of the circuit breaker device can involve values delivered to the control unit from the component of the unit or from the unit, for example from the voltage sensor unit or current sensor unit, for example values of the ascertained level of the voltage or of the current, not exceeding or undershooting defined limit values (upper or/and lower limit values).

This has the particular advantage that a circuit breaker device having faulty or defective components or units is not switched on (no current flow through high-impedance switching elements is made possible), and so increased operational safety in the low-voltage circuit is achieved.

In one advantageous configuration of the invention, in the absence of functionality (absence of functionality of the circuit breaker device during the self-test) the contacts of the mechanical isolating contact unit are opened.

This has the particular advantage that a circuit breaker device having faulty or defective components or units is not only not switched on but electrical isolation is also brought about, as a result of which, on the one hand, further increased operational safety in the low-voltage circuit is achieved and, on the other hand, feedback is given to the user about the absence of functionality of the circuit breaker device.

In one advantageous configuration of the invention, the functionality of the electronic interruption unit is checked in order to determine whether the semiconductor-based switching element is functional.

This can be carried out, for example, by briefly switching on the electronic interruption unit, i.e. briefly switching the semiconductor-based switching element to low-impedance.

In this instance, briefly means a particular period of time, in particular a period of time of less than 1 ms or less than 5 ms.

Furthermore, briefly means a time range of the phase angle of the AC voltage, during which the instantaneous voltage value u(t) of the AC voltage, in particular the absolute value of the instantaneous voltage value, is less than a particular voltage value, for example is less than or equal to 50 volts. That is to say that if the (absolute value of the) instantaneous voltage value (=instantaneous value of the voltage) is less than 50 volts, the electronic interruption unit can be switched to low-impedance for this period/this period of time or for part of this period/this period of time for the purpose of checking the functionality. The level of the current or the level of the voltage at the load-side connection, which is ascertained during this brief switching-on, for example by a second voltage sensor unit, can be evaluated in order to infer a functionality of the electronic interruption unit or of the semiconductor-based switching element. If, during the brief switching-on, the voltage level at the load-side connection is the same as at the network-side connection, the electronic interruption unit or the semiconductor-based switching element for example is functional (inasmuch as there is no short circuit at the load-side connection). In addition, the level of the current can therefore be evaluated in a parallel manner.

This has the particular advantage that a circuit breaker device having a faulty or defective electronic interruption unit is not switched on (no current flow through high-impedance switching elements is made possible), and so increased operational safety in the low-voltage circuit is achieved. Moreover, a simple possible way of checking the functionality of the electronic interruption unit is given.

In one advantageous configuration of the invention, the functionality of the electronic interruption unit is checked in order to determine whether an overvoltage protection component, such as an energy absorber or overvoltage protection element, of the electronic interruption unit is functional.

The check can be carried out, for example, by briefly switching on the electronic interruption unit, i.e. briefly switching the semiconductor-based switching element to low-impedance, see above. A check can be carried out by monitoring the level of the voltage or/and of the current since an overvoltage protection component usually produces short-term current flows during such switching operations, which current flows can be evaluated. Functionality can be inferred therefrom.

This has the particular advantage that a circuit breaker device having a faulty or defective electronic interruption unit is not switched on (no current flow through high-impedance switching elements is made possible), and so increased operational safety in the low-voltage circuit is achieved. Moreover, a simple possible way of checking the functionality of a component of the electronic interruption unit is given.

In one advantageous configuration of the invention, the (first) voltage sensor unit is checked with regard to its functionality for ascertaining the level of the voltage. On the one hand, this can be carried out, for example, by virtue of the (first) voltage sensor unit providing values of the level of the voltage which do not exceed defined limit values (upper or/and lower limit values) and/or are in an expected range of values.

Alternatively, this can be carried out by virtue of a second voltage sensor unit being provided, for example the first voltage sensor unit at the network-side connection and a second voltage sensor unit at the load-side connection, wherein the two voltage values are compared with one another, in particular with a switched-off/switched-on electronic interruption unit (and closed contacts). Conclusions about the functionality for ascertaining the level of the voltage can be drawn from corresponding differences in the levels of the voltage, for example with a switched-on electronic interruption unit. If the voltage difference is too high, for example, there is no functionality.

This has the particular advantage that a circuit breaker device having a faulty or defective voltage sensor unit is not switched on (no current flow through high-impedance switching elements is made possible), and so increased operational safety in the low-voltage circuit is achieved. Moreover, a simple possible way of checking the functionality of a unit, in this case of the voltage sensor unit of the electronic interruption unit, is given.

In one advantageous configuration of the invention, the current sensor unit is checked with regard to its functionality for ascertaining the level of the current.

The check can be carried out, for example, by briefly switching on the electronic interruption unit, i.e. briefly switching the semiconductor-based switching element to low-impedance, see above. The ascertained current level can be checked by monitoring the level of the current, in particular while simultaneously ascertaining the level of the voltage. If the value of the ascertained current level is in an expected range of values, there is functionality, for example, otherwise not, for example.

This has the particular advantage that a circuit breaker device having a faulty or defective electronic interruption unit is not switched on (no current flow through high-impedance switching elements is made possible), and so increased operational safety in the low-voltage circuit is achieved. Moreover, a simple possible way of checking the functionality of a unit (component(s) of a unit), of the current sensor unit, is given.

In one advantageous configuration of the invention, the circuit breaker device is configured in such a way that the temperature of the device, of a unit or/and of a component is/are monitored. In particular, monitoring the temperature of the microprocessor, of the semiconductor-based switching elements or of other semiconductor elements is advantageous here.

If the temperature exceeds particular temperature limit values, the functionality is absent or is at risk.

This has the particular advantage that a circuit breaker device having non-functional units or components is not switched on (no current flow through high-impedance switching elements is made possible), and so increased operational safety in the low-voltage circuit is achieved.

In one advantageous configuration of the invention, the checking function carries out a check of at least one, in particular a plurality or all, of the following parameters:
checking whether a first overvoltage value or/and higher second overvoltage value or/and higher third overvoltage value, in particular at or in the region of the network-side connection, is/are exceeded,
checking whether a first undervoltage value, in particular at or in the region of the network-side connection, is undershot,
checking whether a first temperature limit value or/and higher second temperature limit value or/and higher third temperature limit value is/are exceeded,
checking parameters of the load-side connection, in particular as to whether a load-side first or/and second resistance value or load-side first or/and second impedance value is/are undershot.

Overvoltage or overvoltage value here means that the valid operating voltage is exceeded. What is not meant are the levels of overvoltage dips, for example in the case of so-called bursts or surges, which can typically be 4 kV or 8 kV (in the case of a 230-volt or 400-volt network), so-called network overvoltages (i.e. for example ten times the normative voltage of the low-voltage circuit).

In particular, the first overvoltage value can be a particular percentage higher than the normative voltage value. For example, in the case of a normative voltage value of 230 volts, for example 10% higher, 230 V+10%.

In particular, the second overvoltage value can be a particular higher percentage higher than the normative voltage value. For example, in the case of a normative voltage value of 230 volts, for example 20% higher, 230 V+20%.

In particular, the third overvoltage value can be a particular yet higher percentage higher than the normative voltage value. For example, in the case of a normative voltage value of 230 volts, for example 30% higher, 230 V+30%.

This has the particular advantage that e.g. a circuit breaker device is not switched on in a network with a differing normative voltage (operating voltage) or in response to a load having incorrect parameters. For example, absent protection can thus be identified and prevented when e.g. a 230-volt circuit breaker device is incorrectly connected to e.g. the two phases with a voltage of 400 volts, and an incorrect supply of an excessively high voltage to a load can be prevented. Potential destruction of the circuit breaker device associated with this can also be prevented. In a similar manner, switching-on in response to a short circuit before connecting the full supply voltage can be identified and prevented. In a similar manner, in the case of excessively low voltages (a 230-volt device in the 115-volt network), problems and absent protection can be prevented. Increased operational safety in the low-voltage circuit is thus achieved.

In one advantageous configuration of the invention, depending on the preceding implementation:
if the first overvoltage value is exceeded overvoltage information is emitted,
if the second overvoltage value is exceeded the electronic interruption unit becomes high-impedance,
if the third overvoltage value is exceeded the contacts are opened (disconnected) by the mechanical isolating contact unit,
if the first undervoltage value is undershot undervoltage information is emitted or/and the electronic interruption unit remains high-impedance (in particular in the case of a third undervoltage limit value), in particular if the voltage level is greater than a second undervoltage value,
if the first temperature limit value is exceeded temperature information is emitted,
if the second temperature limit value is exceeded the electronic interruption unit becomes high-impedance,
if the third temperature limit value is exceeded the contacts are opened (disconnected),
if the load-side first resistance value or load-side first impedance value is undershot impedance information is emitted, or
if the load-side second resistance value or load-side second impedance value is undershot the electronic interruption unit remains high-impedance.

This has the particular advantage that defined measures—warning—remain high-impedance—electrical isolation—are carried out in a graduated manner depending on whether particular defined parameters are exceeded or undershot. Increased operational safety in the low-voltage circuit is thus achieved.

In one advantageous configuration of the invention, the checking function carries out the check of at least one, in particular a plurality or all, of the parameters continuously. This is carried out in particular if the contacts were not opened. In the event that the respective parameter(s) is/are no longer exceeded or undershot, respectively, a low-impedance state of the switching elements is allowed.

This has the particular advantage that a differentiated behavior of the circuit breaker device is made possible. When functionality of the circuit breaker device is absent, electrical isolation is generally brought about, for example. In the case of differing parameters at the network- or/and load-side connection which do not exceed certain limit values, the circuit breaker device remains in the connected—but not switched-on—state until the parameters are possibly in the normal range. High flexibility is thus achieved at the same time as high safety.

In one advantageous configuration of the invention, in the case of a connected isolating contact unit and a low-impedance interruption unit and
in the case of an ascertained current exceeding a first current threshold value, in particular in that the first current threshold value is exceeded for a first period of time, the electronic interruption unit becomes high-impedance and the mechanical isolating contact unit remains closed.

Furthermore:
in the case of an ascertained current exceeding a second current threshold value, in particular for a second period of time, the electronic interruption unit can become high-impedance and the mechanical isolating contact unit can be opened.

Furthermore:
in the case of an ascertained current exceeding a third current threshold value, immediately or practically immediately the electronic interruption unit becomes high-impedance. Alternatively, the mechanical isolating contact unit can additionally be opened.

This has the particular advantage that there is a graduated switch-off concept for a circuit breaker device according to the invention.

In one advantageous configuration of the invention, the circuit breaker device is configured in such a way that the contacts of the mechanical isolating contact unit can be opened, but not closed, by the control unit.

This has the particular advantage that increased operational safety in the low-voltage circuit is achieved, in particular that remote electronic connection is not possible.

In one advantageous configuration of the invention, the contact position of the mechanical isolating contact unit is (mechanically) displayed.

This has the particular advantage that a visual check of the contact position is possible even in the deenergized state. Increased operational safety in the low-voltage circuit is therefore achieved.

In one advantageous configuration of the invention, the mechanical isolating contact unit comprises a trip-free mechanism such that if, after the start of a closing process of the contacts an opening of the contacts is initiated, the contacts return to the open position even if the closing process continues to be maintained.

Or in other words, the moving contacts return to the open position and remain therein if the opening of the contacts is initiated after the start of the closing of the contacts even if the process of closing the contacts remains maintained by the handle.

This has the particular advantage that increased operational safety in the low-voltage circuit is achieved. In the case of connection in response to an unrecognized (unknown) short circuit, the user actuates the handle of the mechanical isolating contact unit and would thus like to close the contacts. However, the contacts must open in the event of a short circuit, which is opposed to the operating direction (the closing of the contacts by the operator). Only the (fast) opening of the contacts counter to the operating direction prevents a larger fault.

In one advantageous configuration of the invention, the circuit breaker device comprises a differential current sensor for ascertaining differential currents in the low-voltage circuit.

This has the particular advantage that a further functionality can be implemented and realized in the circuit breaker device. The circuit breaker device can thus be enhanced by a fault-current-identification function. A compact, multi-purpose circuit breaker device is available.

According to the invention, a corresponding method for a circuit breaker device for a low-voltage circuit having electronic (semiconductor-based) switching elements having the same and further advantages is claimed.

The method for a circuit breaker device for protecting an electrical low-voltage circuit, comprising:
ascertainment of the level of the current of the low-voltage circuit,
a mechanical isolating contact unit which is able to be operated using a mechanical handle, with the result that opening of contacts in order to prevent a current flow or closing of the contacts for a current flow in the low-voltage circuit can be switched,
an electronic interruption unit which is connected in series with the mechanical isolating contact unit on the circuit side and which, as a result of semiconductor-based switching elements, has a high-impedance state of the switching elements in order to prevent a current flow and a low-impedance state of the switching elements for the current flow in the low-voltage circuit,
wherein the ascertained level of the current is compared with current limit values and if the current limit values are exceeded a process for preventing the current flow in the low-voltage circuit is initiated in order to prevent a short-circuit current.

According to the invention, a user of the circuit breaker device can operate the mechanical handle (for a switching-on process) in order to close the contacts (connection process), wherein the electronic interruption unit is high-impedance,
after the contacts have been closed, the electronic interruption unit becomes low-impedance only if a checking function allows a low-impedance state of the switching elements.

According to the invention, a corresponding computer program product is claimed. The computer program product comprises commands which, when the program is executed by a microcontroller, cause the latter to carry out a checking function for a circuit breaker device as claimed in one of patent claims 1 to 15. The microcontroller is part of the circuit breaker device, in particular of the control unit. According to the invention, a corresponding computer-readable storage medium on which the computer program product is stored is claimed.

According to the invention, a corresponding data carrier signal which transmits the computer program product is claimed.

All configurations, both in dependent form referring back to patent claim 1 or 14 and referring back only to individual features or combinations of features of patent claims, in particular also a reference of the dependent arrangement claims back to the independent method claim, result in an improvement in a circuit breaker device, in particular an improvement in the safety of a circuit breaker device, and provide a novel safe concept for a circuit breaker device.

The described properties, features and advantages of this invention and the way in which they are achieved will become clearer and more distinctly comprehensible in connection with the following description of the exemplary embodiments which are explained in more detail in connection with the drawing.

In the drawing:

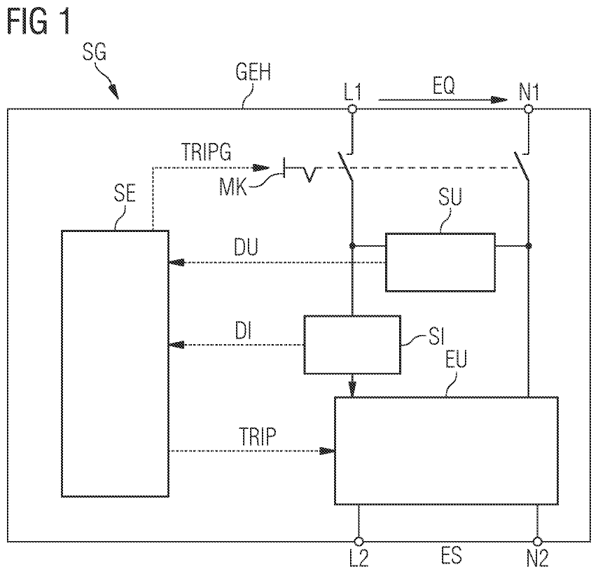

FIG. 1 shows a first illustration of a circuit breaker device,

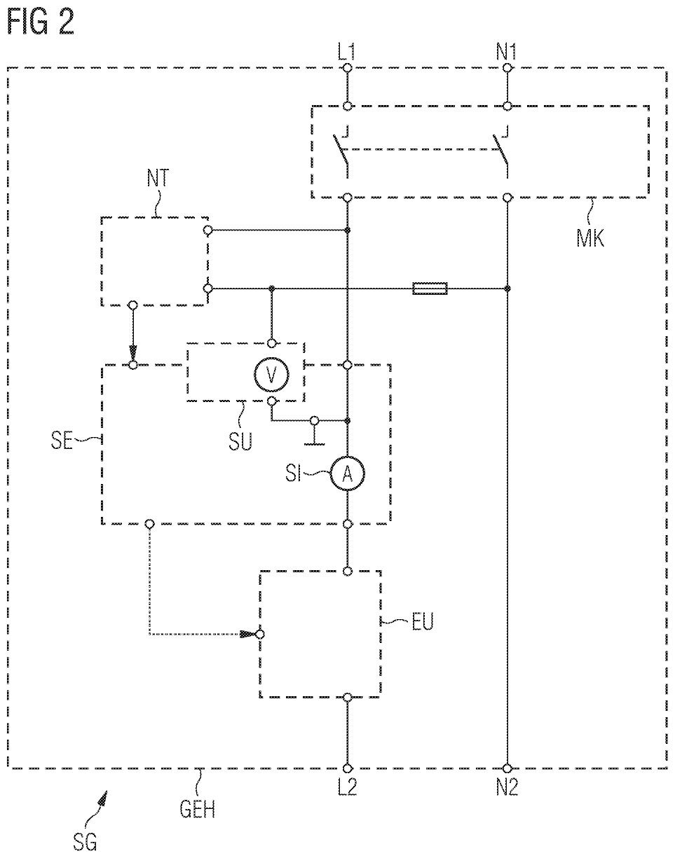

FIG. 2 shows a second illustration of a circuit breaker device,

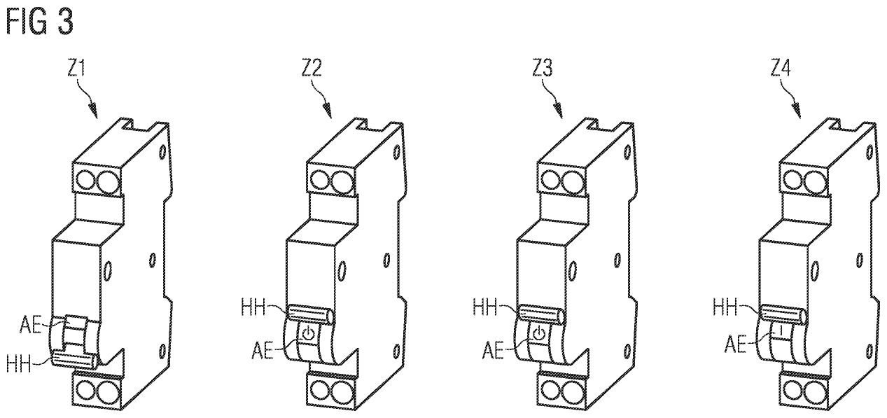

FIG. 3 shows a third illustration of a circuit breaker device,

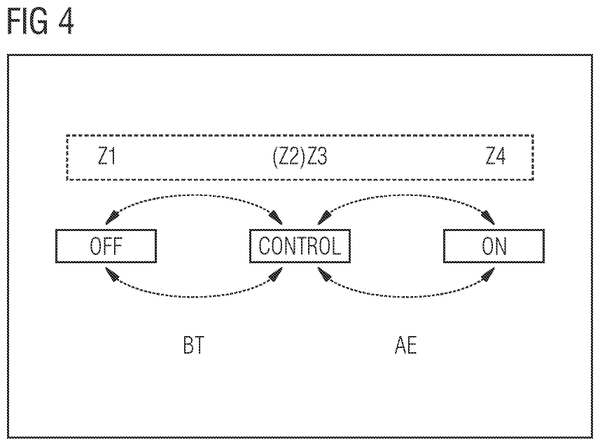

FIG. 4 shows an illustration of states of a circuit breaker device,

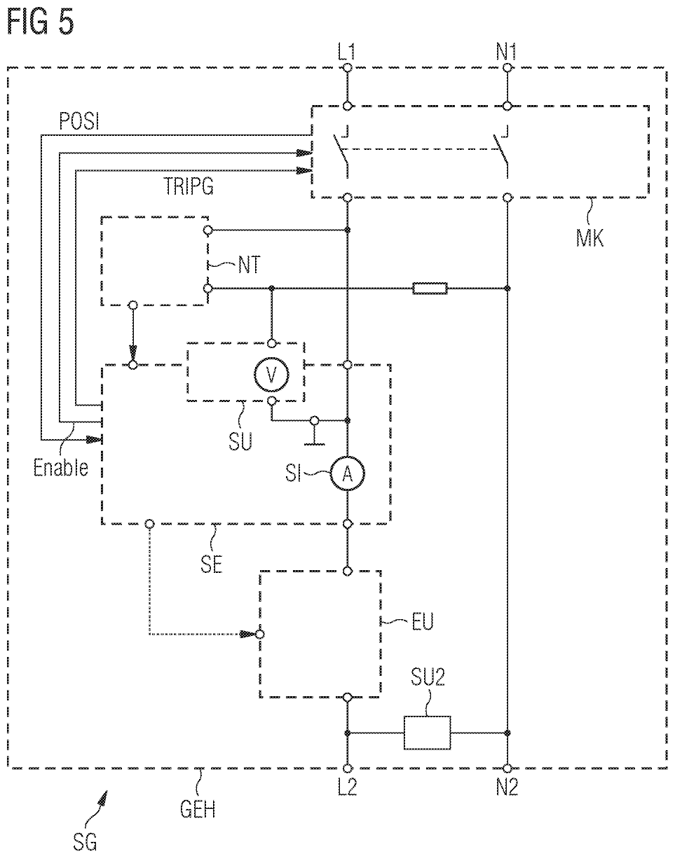

FIG. 5 shows a fourth illustration of a circuit breaker device.

FIG. 1 shows an illustration of a circuit breaker device SG for protecting an electrical low-voltage circuit, having a housing GEH, comprising:
connections for conductors of the low-voltage circuit, in particular first network-side connections L1, N1 for a network-side, in particular energy-source-side, connection EQ of the circuit breaker device SG and second load-side connections L2, N2 for a load-side, in particular energy-sink-side—in the case of passive loads, connection ES (consumer-side connection) of the circuit breaker device SG, wherein phase-conductor-side connections L1, L2 and neutral-conductor-side connections N1, N2 may specifically be provided;
the load-side connection L2, N2 can comprise a passive load (consumer) or/and an active load ((further) energy source), or a load which can be both passive and active, e.g. in a time sequence;
a (first) voltage sensor unit SU for ascertaining the level of the voltage of the low-voltage circuit such that in particular instantaneous (phase-angle-related) voltage values DU are available,
a current sensor unit SI for ascertaining the level of the current of the low-voltage circuit in such a way that in particular instantaneous (phase-angle-related) current values DI are available,
a mechanical isolating contact unit MK which is able to be switched and able to be operated in particular using a mechanical handle, with the result that opening of contacts in order to prevent a current flow or closing of the contacts for a current flow in the low-voltage circuit is able to be switched (by means of the handle), so that (in particular) electrical isolation in the low-voltage circuit is able to be switched;
in the case of the mechanical isolating contact unit MK, opening of contacts is also referred to as disconnection, and closing of contacts is referred to as connection;
an electronic interruption unit EU which is connected in series with the mechanical isolating contact unit on the circuit side and which, as a result of semiconductor-based switching elements, has a high-impedance state of the switching elements in order to prevent a current flow and a low-impedance state of the switching elements for the current flow in the low-voltage circuit;
in the case of the electronic interruption unit EU, a high-impedance state of the switching elements (for preventing a current flow) is also referred to as a switched-off state (process: switching off) and a low-impedance (conductive) state of the switching elements (for the current flow) is referred to as a switched-on state (process: switching on);
a control unit SE which is connected to the (first) voltage sensor unit SU, to the current sensor unit SI, to the mechanical isolating contact unit MK and to the electronic interruption unit EU, wherein if current limit values or current-time limit values are exceeded (i.e. if a current limit value is exceeded for a particular period of time) a process for preventing a current flow in the low-voltage circuit is initiated, in particular in order to prevent a short-circuit current.

In the example according to FIG. 1, the network-side connections L1, N1 are connected, on the one hand, to the mechanical isolating contact unit MK. The mechanical isolating contact unit MK is connected, on the other hand, to the electronic interruption unit EU. The electronic interruption unit EU is connected, on the other hand, to the load-side connections L2, N2.

In an alternative variant, the mechanical isolating contact unit MK is connected to the load-side connections L2, N2 and the electronic interruption unit EU is connected to the network-side connections L1, N1.

That is to say that the mechanical isolating contact unit MK is connected in series with the electronic interruption unit EU, wherein the mechanical isolating contact unit MK is assigned to the load-side connections and the electronic interruption unit EU is assigned to the network-side connections.

In this alternative variant, a power supply unit for supplying energy is then advantageously connected (directly) to the network-side connections such that it is constantly supplied with energy from the network-side connections and the energy source EQ usually present there.

In this variant, the checking function can for example/in particular already be started or carried out before the closing of the contacts of the mechanical isolating contact unit.

The (first) voltage sensor unit SU and the current sensor unit SI are arranged between the mechanical isolating contact unit MK and the electronic interruption unit EU.

A second voltage sensor unit (SU2) can be arranged between the electronic interruption unit EU and the load-side connections L2, N2.

The circuit breaker device SG can comprise an energy supply having a power supply unit NT (not shown in FIG. 1). The power supply unit NT is connected, on the one hand, to the conductors of the low-voltage circuit, preferably to the conductors between the mechanical isolating contact system MK and the electronic interruption unit EU. The power supply unit NT is used, on the other hand, to supply energy to the control unit SE or/and to the electronic interruption unit EU and possibly to the first (or/and second) voltage sensor SU or/and current sensor SI.

The circuit breaker device SG, in particular the control unit SE, can comprise a microcontroller (=microprocessor) on which runs a computer program product comprising commands which, when the program is executed by the microcontroller, cause the latter to carry out a checking function (as described above and below) for a circuit breaker device.

The computer program product can advantageously be stored on a computer-readable storage medium; such as a USB stick, CD-ROM, etc., in order to allow an upgrade to an enhanced version, for example.

Alternatively, the computer program product can also advantageously be transmitted by a data carrier signal.

The control unit SE can:
be produced with a digital circuit, e.g. with a (further) microprocessor; the (further) microprocessor can also contain an analog part;
be produced with a digital circuit having analog circuit parts.

The circuit breaker device SG, in particular the control unit SE, is configured in such a way that if current limit values or current-time limit values are exceeded (i.e. if a current limit value is exceeded for a particular period of time) a process for preventing a current flow in the low-voltage circuit is initiated, in particular in order to prevent a short-circuit current. This is achieved in particular by virtue of the electronic interruption unit EU changing from the low-impedance state to the high-impedance state. The process for preventing a current flow in the low-voltage circuit is initiated, for example, by a first interruption signal TRIP which is sent from the control unit SE to the electronic interruption unit EU, as shown in FIG. 1.

According to FIG. 1, the electronic interruption unit EU is shown as a block in both conductors. Therefore, in a first variant, this means no interruption of both conductors. At least one conductor, in particular the active conductor or rather phase conductor, comprises semiconductor-based switching elements. The neutral conductor can be free of switching elements, i.e. without semiconductor-based switching elements. That is to say that the neutral conductor is connected directly, i.e. does not become high-impedance. That is to say that only single-pole interruption (of the phase conductor) takes place. If further active conductors/phase conductors are provided, in a second variant of the electronic interruption unit EU, the phase conductors comprise semiconductor-based switching elements. The neutral conductor is connected directly, i.e. does not become high-impedance. For example for a three-phase AC circuit.

In a third variant of the electronic interruption unit EU, the neutral conductor can likewise comprise a semiconductor-based switching element, i.e. both conductors become high-impedance when the electronic interruption unit EU is interrupted.

The electronic interruption unit EU can comprise semiconductor components such as bipolar transistors, field-effect transistors (FETs), isolated-gate bipolar transistors (IGBTs), metal-oxide-layer field-effect transistors (MOSFETs) or other (self-commutated) power semiconductors. In particular, IGBTs and MOSFETs are particularly well suited to the circuit breaker device according to the invention owing to low flow resistances, high junction resistances and good switching behavior.

In a first variant, the mechanical isolating contact unit MK can carry out single-pole interruption. That is to say that only one conductor of the two conductors, in particular the active conductor or rather phase conductor, is interrupted, i.e. has a mechanical contact. The neutral conductor is then free of contacts, i.e. the neutral conductor is connected directly.

If further active conductors/phase conductors are provided, in a second variant, the phase conductors comprise mechanical contacts of the mechanical isolating contact system. In this second variant, the neutral conductor is connected directly. For example for a three-phase AC circuit.

In a third variant of the mechanical isolating contact system MK, the neutral conductor likewise comprises mechanical contacts, as shown in FIG. 1.

Mechanical isolating contact unit MK means in particular a (standard-compliant) isolating function, provided by the isolating contact unit MK. Isolating function means the following points:
minimum air gap according to the standard (minimum distance between the contacts),
contact position display of the contacts of the mechanical isolating contact system,
actuation of the mechanical isolating contact system always possible (no blocking of the isolating contact system).

With regard to the minimum air gap between the contacts of the isolating contact system, this is substantially voltage-dependent. Further parameters are the degree of soiling, the type of field (homogeneous, inhomogeneous) and the air pressure or the height above sea level.

There are appropriate regulations or standards for these minimum air gaps or creepage distances. In air, for example, these regulations indicate the minimum air gap for a surge withstand capability for an inhomogeneous and a homogeneous (ideal) electrical field on the basis of the degree of soiling. The surge withstand capability is the strength when an applicable surge voltage is applied. Only if this minimum length (minimum distance) exists does the isolating contact system or circuit breaker device have an isolating function (isolator property).

Within the context of the invention, the series of standards DIN EN 60947, or IEC 60947, which are mentioned here by way of reference, are relevant to the isolator function and the properties thereof in this instance.

The isolating contact system is advantageously characterized by a minimum air gap between the open isolating contacts in the OFF position (open position, open contacts) on the basis of the rated surge withstand capability and the degree of soiling. The minimum air gap is in particular between (a minimum of) 0.01 mm and 14 mm. In particular, the minimum air gap is advantageously between 0.01 mm at 0.33 kV and 14 mm at 12 kV, in particular for degree of soiling 1 and in particular for inhomogeneous fields.

The minimum air gap can advantageously have the following values:

E DIN EN 60947-1 (VDE 0660-100):2018-06

TABLE 13
minimum air gaps

| | Minimum air gaps mm | | | | | | | |
|---|---|---|---|---|---|---|---|---|
| Rated surge | Case A | | | | Case B | | | |
| withstand | inhomogeneous field | | | | homogeneous field, ideal conditions | | | |
| capability | (see 3.7.63) | | | | (see 3.7.62) | | | |
| [symbol] | Degree of soiling | | | | Degree of soiling | | | |
| kV | 1 | 2 | 3 | 4 | 1 | 2 | 3 | 4 |
| 0.33 | 0.01 | 0.2 | 0.8 | 1.6 | 0.01 | 0.2 | 0.8 | 1.6 |
| 0.5 | 0.04 | | | | 0.04 | | | |
| 0.8 | 0.1 | | | | 0.1 | | | |
| 1.5 | 0.5 | 0.5 | | | 0.3 | 0.3 | | |
| 2.5 | 1.5 | 1.5 | 1.5 | | 0.6 | 0.6 | | |
| 4.0 | 3 | 3 | 3 | 3 | 1.2 | 1.2 | 1.2 | |
| 6.0 | 5.5 | 5.5 | 5.5 | 5.5 | 2 | 2 | 2 | 2 |
| [symbol] .0 | 8 | 8 | 8 | 8 | 3 | 3 | 3 | 3 |
| 12 | 14 | 14 | 14 | 14 | 4.5 | 4.5 | 4.5 | 4.5 |

NOTE
The smallest air gaps indicated are based on the 1.2/50-μs surge voltage at an air pressure of 80 kPa, corresponding to the air pressure at 2000 m above sea level. [symbol]
indicates data missing or illegible when filed

The degrees of soiling and types of field are consistent with those defined in the standards. As a result, a standard-compliant circuit breaker device dimensioned according to the rated surge withstand capability can advantageously be achieved.

The mechanical isolating contact unit MK can alternatively or additionally be controlled by the control unit SE in order to initiate a process for preventing a current flow in the low-voltage circuit if current limit values or current-time limit values are exceeded. Electrical isolation is specifically brought about in this instance, if necessary. The process for preventing a current flow, or possible electrical interruption of the low-voltage circuit, is initiated, for example, by a second interruption signal TRIPG which is sent from the control unit SE to the mechanical isolating contact system MK, as shown in FIG. 1.

In one advantageous configuration, in the case of an ascertained current level exceeding the second current threshold value, an interruption of the low-voltage circuit can be initiated, in particular by means of the mechanical isolating contact unit MK.

The second current threshold value corresponds, for example, to the standard-compliant current-(time) limit values, i.e. the I(−t) characteristic curves for protection devices, for example according to the IEC 60947 or IEC 60898 standard. The selected current-(time) limit values are selected by a person skilled in the art according to the present use/application.

In a similar manner, the third current threshold value can be selected, for example, according to standard-compliant current-time limit values, i.e. the I-t characteristic curves for protection devices, for example according to the IEC 60947 or IEC 60898 standard. The selected current-time limit values are selected by a person skilled in the art according to the present use/application.

According to the invention, the circuit breaker device SG is configured in such a way that the electronic interruption unit EU is high-impedance in the disconnected state, i.e. when the contacts of the mechanical isolating contact unit MK are open. If a user of the circuit breaker device SG operates the mechanical handle for a switching-on process in order to close the contacts, a checking function is carried out, in particular after closing the contacts (i.e. connection). If the checking function delivers a positive result, the electronic interruption unit EU becomes low-impedance. Otherwise not.

That is to say that the electronic interruption unit EU only becomes low-impedance if the checking function allows a low-impedance state of the switching elements.

FIG. 2 shows an illustration of a circuit breaker device SG according to FIG. 1 with the difference that:
the electronic interruption unit EU is in the form of a unit which carries out single-pole interruption,
the mechanical isolating contact unit MK is in the form of a unit which carries out two-pole interruption (electrically interrupting),
provision is made for a power supply unit NT which is connected between the mechanical isolating contact unit MK and the electronic interruption unit EU,
the power supply unit NT supplies energy to the control unit SE (indicated by an arrow).

FIG. 3 shows one possible external illustration of a circuit breaker device SG according to FIG. 1 or 2. FIG. 3 shows a circuit breaker device SG which is able to be mounted on a top-hat rail and has a width of e.g. 1 HP, 1.5 HP or 2 HP having two-pole connections (L, N).

In electrical installation and in switchgear cabinet construction, the width of built-in devices such as circuit breaker devices, miniature circuit breakers, fault-current circuit breakers, etc. is specified in horizonal pitch units, HP for short. The width of a horizontal pitch unit is ˜18 mm. The installation width of the devices should be between 17.5 and 18.0 mm according to the DIN 43880:1988-12 standard, or be calculated by multiplying this dimension by 0.5 or an integer multiple thereof, that is to say: k×0.5×18 mm or k×0.5×17.5 mm (where k=1, 2, 3, . . . ). A single-pole miniature circuit breaker thus has a width of 1 HP, for example. The built-in equipment of electrical installation distribution boards are matched to the horizontal pitch units, e.g. the width of mounting rails/top-hat rails, according to DIN 43871 “Consumer units for built-in equipment up to 63 A”.

FIG. 3 shows the circuit breaker device SG having a handle HH for the mechanical isolating contact unit MK. The handle HH of the mechanical isolating contact unit MK is able to be operated by a user, i.e. connection and disconnection can be carried out. The circuit breaker device SG according to FIG. 3 comprises a display unit AE for displaying information on the circuit breaker device SG. In the example according to FIG. 3, the display unit AE is integrated in the handle HH.

The handle HH can advantageously be used as a contact position display here (in particular can be part of the display unit AE).

The display unit AE comprises e.g. (at least) one LED/light-emitting diode, for example a two-color light-emitting diode which can e.g. flash yellow or shine red. In the example according to FIG. 3, the LED is partially covered depending on the position of the handle.

Four states Z1, Z2, Z3, Z4 of the circuit breaker device SG are illustrated in FIG. 3.

In the first state Z1, the circuit breaker device SG is disconnected and switched off, i.e. the mechanical isolating contact unit MK is open and the electronic interruption unit EU is high-impedance. The display unit AE displays, for example, a green state, for example by way of a color marking, at or in the region of the handle HH in the example.

In a second state Z2, the circuit breaker device SG is connected and switched off, i.e. the mechanical isolating contact unit MK is closed and the electronic interruption unit EU is high-impedance. However, the circuit breaker device SG does not have an energy supply because the electrical low-voltage circuit is voltage-free, for example. The display unit AE displays, for example, a yellow state, for example by way of a color marking, at or in the region of the handle HH in the example.

In a third state Z3, the circuit breaker device SG is connected but is still switched off, i.e. the mechanical isolating contact unit MK is closed and the electronic interruption unit EU is high-impedance. The circuit breaker device SG is (normally) supplied with energy. However, the circuit breaker device SG has not yet been switched on, i.e. current cannot yet flow in the electrical low-voltage circuit. In this state, the circuit breaker device SG carries out its checking function, for example. The display unit AE displays, for example, a flashing yellow state, for example by way of a flashing LED, at or in the region of the handle HH in the example, as indicated in FIG. 3.

In a fourth state Z4, the circuit breaker device SG is connected and switched on, i.e. the mechanical isolating contact unit MK is closed and the electronic interruption unit EU is low-impedance. (The circuit breaker device SG is (normally) supplied with energy.) A current can flow in the electrical low-voltage circuit. In this state, the circuit breaker device SG has ended its checking function with a positive result, for example. The display unit AE displays, for example, a red state, for example by way of an LED/light-emitting diode shining red, at or in the region of the handle HH in the example, as indicated in FIG. 3.

FIG. 4 shows an illustration of the states Z1, Z2, Z3, Z4 of the circuit breaker device SG. In this case, the second and third states Z2, Z3 are combined to form a mode Control. That is to say that the circuit breaker device SG has substantially three modes. A first mode OFF in which the mechanical isolating contact unit MK is open and the electronic interruption unit EU is high-impedance; a second mode CONTROL in which the mechanical isolating contact unit MK is closed and the electronic interruption unit EU is high-impedance; a third mode ON in which the mechanical isolating contact unit MK is closed and the electronic interruption unit EU is low-impedance.

A change from the first mode OFF to the second mode CONTROL is only possible manually by a user by means of actuation BT of the handle. A change from the second mode CONTROL back to the first mode OFF is possible manually by a user by means of actuation BT of the handle and optionally by the control unit SE.

A change from the second mode CONTROL to the third mode ON and back is only possible “automatically” by the circuit breaker device SG itself, by means of an automatic switching-on process AE (or automatic switching-off process—for example when a short-circuit condition is met). In particular, a change from the second mode CONTROL to the third mode ON cannot be forced by a user.

The checking function comprises a self-test of the functionality of the circuit breaker device. During this self-test, at least one component, in particular a plurality of components, of a unit, in particular of a plurality of units, of the circuit breaker device SG is/are checked. If the checked components or units are functional, the low-impedance state is allowed. Otherwise, disconnection can advantageously be carried out, i.e. the contacts are opened (in particular electrical isolation is brought about).

A self-test of the functionality of at least one component of a unit of the circuit breaker device can involve values delivered to the control unit from the component of the unit or from the unit, for example from the voltage sensor unit or current sensor unit, for example values of the ascertained level of the voltage or of the current, not exceeding defined limit values (upper or/and lower limit values).

A further self-test can involve briefly switching on the electronic interruption unit, i.e. briefly switching the semiconductor-based switching element to low-impedance. In this case, briefly means a particular period of time during which the instantaneous voltage value u(t) of the AC voltage does not exceed a particular value, for example 50 volts. For example, the AC voltage can thus be connected (electronic interruption unit EU is low-impedance) at the zero crossing of the AC voltage (0°) for approx. 444 μs/up to 8°, i.e. until the instantaneous voltage value of at most 50 volts is reached.

Alternatively, it is also possible to switch on at approx. −8° (based on the zero crossing of the AC voltage), to pass through the zero crossing and to switch off again at +8°, that is to say for approx. 888 μs. That is to say that the switch-on period of time is less than 1 ms, in particular less than 0.9 ms, specifically about 0.8 ms (or half in each case, depending on the switch-on time in each case).

This brief switching-on makes it possible to check various units or the components thereof:
the electronic interruption unit EU,
the current sensor unit SI,
the voltage sensor unit SU.

For a further check, provision can be made for a second voltage sensor unit SU2 which is provided between the electronic interruption unit EU and the load-side connection, i.e. at the load-side connection, as shown in FIG. 5. FIG. 5 shows an illustration of a circuit breaker device SG according to FIG. 2 with the difference that a corresponding second voltage sensor unit SU2 is provided.

Moreover, provision is made in FIG. 5 for a release unit/release function (which is not illustrated in more detail) which brings about a release of the actuation of the contacts of the mechanical isolating contact unit by way of the handle HH. That is to say that if a release signal Enable is present, which in the example according to FIG. 5 is sent from the control unit to the isolating contact unit, closing the contacts KKL, KKN is only possible by way of the handle. Otherwise, closing is not possible (permanent slider contact of the handle HH). The contacts remain in the open position/switching state. This release unit/function is appropriate depending on the architecture of the circuit breaker device, in particular if the electronic interruption unit is connected to the network-side connection or the control unit is supplied with energy even in the open state of the contacts.

Furthermore, in FIG. 5, the circuit breaker device, in the example the mechanical isolating contact unit, is configured in such a way that position information relating to the contacts (open/closed) is ascertained and transmitted to the control unit SE, for example by a position signal POSI. The position information can be ascertained, for example, by a first position sensor which is in particular provided in or on the mechanical isolating contact unit and is connected to the control unit.

Alternatively or in addition, handle information relating to the position of the handle (open/closed) can be ascertained and transmitted to the control unit SE (by a handle position signal (not shown)). The handle information can be ascertained, for example, by a second position sensor which is connected to the control unit.

That is to say that the circuit breaker device is advantageously configured in such a way that position information relating to the contacts (open/closed) is ascertained and is transmitted to the control unit SE. The position information can be ascertained, for example, by a first position sensor which is connected to the control unit.

That is to say that the circuit breaker device is advantageously configured in such a way that handle information relating to the position of the handle (open/closed) is ascertained and transmitted to the control unit SE. The handle information can be ascertained, for example, by a second position sensor which is connected to the control unit.

If, during the brief switching-on, the voltage level at the load-side connection is the same as at the network-side connection, the electronic interruption unit or the semiconductor-based switching element for example is functional (inasmuch as there is no short circuit across the load-side connection). In addition, the level of the current can be evaluated in a parallel manner.

Functionality of the units can be inferred from the ascertained current and voltage values.

The self-test of the device can further comprise a temperature measurement, for example of the microprocessor or of the semiconductor-based switching elements. It is possible to check the control unit, for example, by monitoring the temperature at the microprocessor.

In addition to the self-test of the device, the checking function can further comprise a test of the low-voltage circuit, more specifically of the load-side or network-side connection. For example, it is possible to check at least one, in particular a plurality or all, of the following parameters:
checking whether a first overvoltage value or/and higher second overvoltage value or/and higher third overvoltage value, in particular at or in the region of the network-side connection, is/are exceeded,
checking whether a first undervoltage value is undershot, in particular at or in the region of the network-side connection,
checking parameters of the load-side connection, in particular as to whether a load-side first or/and second resistance value or load-side first or/and second impedance value is/are undershot.

Overvoltage values and undervoltage values can be checked by specific measurements by the voltage sensor unit. The limit values can be stipulated as already described.

The checking of parameters of the load-side connection, in particular as to whether a load-side first or/and second resistance value or load-side first or/and second impedance value is/are undershot, can likewise be carried out, for example, by briefly switching on the electronic interruption unit and by measurements by the voltage sensor unit and current sensor unit. The ascertained values are compared with the stipulated first or/and second resistance or/and impedance values.

Depending on the implementation of the parameters that are to be checked, i.e. the preceding implementation:
if the first overvoltage value is exceeded overvoltage information can be emitted (voltage too high),
if the second overvoltage value is exceeded the electronic interruption unit can become high-impedance (voltage level critical),
if the third overvoltage value is exceeded the contacts can be opened (disconnected) using the mechanical isolating contact unit (voltage level dangerous (for further operation of the device)),
if the first undervoltage value is undershot undervoltage information can be emitted (device capable of working and capable of protection, but “voltage in the network too low”), if a third undervoltage value is undershot the electronic interruption unit remains high-impedance (voltage too low, device no longer capable of protection), in particular if the voltage level is greater than a second undervoltage value (otherwise no display or action can be performed since the voltage is too low),
if the first temperature limit value is exceeded temperature information is emitted (increased temperature),
if the second temperature limit value is exceeded the electronic interruption unit becomes high-impedance (critical temperature),
if the third temperature limit value is exceeded the contacts are opened (disconnected) (temperature too high (for safe operation of the device)),
if the load-side first resistance value or load-side first impedance value is undershot impedance information is emitted (low-impedance consumer—overload?), or
if the load-side second resistance value or load-side second impedance value is undershot the electronic interruption unit remains high-impedance (short circuit on the load side).

Defined measures—warning—remain high-impedance—electrical isolation—can therefore be carried out in a graduated manner depending on whether particular defined parameters are exceeded or undershot, which increases the operational safety in the low-voltage circuit. Advantageously, the check is carried out continuously with closed contacts/connection. If the parameters are in the intended range, i.e. the range is not exceeded or undershot, switching-on can be carried out (low-impedance switching elements).

High impedance means a state in which only a current of a negligible magnitude flows. In particular, high impedance means resistance values of greater than 1 kiloohm, preferably greater than 10 kiloohms, 100 kiloohms, 1 megohm, 10 megohms, 100 megohms, 1 gigaohm or greater.

Low impedance means a state in which the specified current value can flow.

In particular, low impedance means resistance values of less than 10 ohms, preferably less than 1 ohm, 100 milliohms, 10 milliohms, 1 milliohm, 100 microohms or less.

Although the invention has been described and illustrated more specifically in detail by means of the exemplary embodiment, the invention is not restricted by the disclosed examples and other variations may be derived therefrom by a person skilled in the art without departing from the scope of protection of the invention.

1-17. (canceled)

18. A circuit breaker device for protecting an electrical low-voltage circuit, the circuit breaker device comprising:
a housing having network-side and load-side connections for conductors of the electrical low-voltage circuit;
a voltage sensor for ascertaining a level of a voltage of the electrical low-voltage circuit;
a current sensor for ascertaining a level of a current of the electrical low-voltage circuit;
a mechanical isolating contact able to be operated using a mechanical handle and having contacts, with a result that opening of said contacts prevent a current flow or closing of said contacts for the current flow in the electrical low-voltage circuit is able to be switched;
an electronic interruption unit connected in series with said mechanical isolating contact on a circuit side and having semiconductor-based switching elements, as a result of said semiconductor-based switching elements, said electronic interruption unit has a high-impedance state of said semiconductor-based switching elements to prevent the current flow and a low-impedance state of said semiconductor-based switching elements for the current flow in the electric low-voltage circuit;
a controller connected to said voltage sensor, to said current sensor, to said mechanical isolating contact and to said electronic interruption unit, wherein if the current and/or current-time limit values is/are exceeded a process for preventing the current flow in the electrical low-voltage circuit is initiated; and
the circuit breaker device is configured such that a user of the circuit breaker device operates said mechanical handle in order to close said contacts, wherein said electronic interruption unit is in the high-impedance state, in that, after said contacts have been closed, said electronic interruption unit goes to the low-impedance state only if a checking function allows the low-impedance state of said semiconductor-based switching elements.

19. The circuit breaker device according to claim 18, further comprising a display for displaying information and is connected to said controller, wherein said display displays a state of said semiconductor-based switching elements of said electronic interruption unit and/or a position of said contacts of said mechanical isolating contact.

20. The circuit breaker device according to claim 18, wherein the checking function contains a self-test of a functionality of the circuit breaker device, during which at least one component of a unit of the circuit breaker device is checked, and if the at least one component of the unit is functional, the low-impedance state is allowed.

21. The circuit breaker device according to claim 20, wherein in an absence of the functionality, said contacts of said mechanical isolating contact are opened.

22. The circuit breaker device according to claim 20, wherein the functionality of said electronic interruption unit is checked in order to determine whether said semiconductor-based switching elements are functional.

23. The circuit breaker device according to claim 20, wherein:
said voltage sensor is checked with regard to its functionality for ascertaining the level of the voltage; and/or
said current sensor is checked with regard to its functionality for ascertaining the level of the current.

24. The circuit breaker device according to claim 18, wherein
the checking function carries out a check of at least one of the following parameters:
checking whether a first overvoltage value and/or a second overvoltage value and/or a third overvoltage value is/are exceeded;
checking whether a first undervoltage value is undershot;
checking whether a first temperature limit value and/or a second temperature limit value and/or a third temperature limit value is/are exceeded; and
checking parameters of said load-side connection, including whether a load-side first and/or second resistance value or a load-side first and/or second impedance value is/are undershot.

25. The circuit breaker device according to claim 24, wherein:
if the first overvoltage value is exceeded overvoltage information is emitted;
if the second overvoltage value is exceeded said electronic interruption unit goes to the high-impedance state;
if the third overvoltage value is exceeded said contacts are opened;
if the first undervoltage value is undershot undervoltage information is emitted or/and said electronic interruption unit remains in the high-impedance state;
if the first temperature limit value is exceeded temperature information is emitted;
if the second temperature limit value is exceeded said electronic interruption unit goes to the high-impedance state;
if the third temperature limit value is exceeded said contacts are opened;
if the load-side first resistance value or the load-side first impedance value is undershot impedance information is emitted; and
if the load-side second resistance value or the load-side second impedance value is undershot said electronic interruption unit remains in the high-impedance state.

26. The circuit breaker device according to claim 24, wherein the checking function carries out a check of at least one of the parameters continuously.

27. The circuit breaker device according to claim 18, wherein:
in a case of a connected said mechanical isolating contact and said electronic interruption unit has the low-impedance state, and:
in a case of an ascertained current exceeding a first current threshold value, said electronic interruption unit goes to the high-impedance state and said mechanical isolating contact remains closed;
in a case of the ascertained current exceeding a second current threshold value, said electronic interruption unit goes to the high-impedance state and said mechanical isolating contact is opened; and
in a case of the ascertained current exceeding a third current threshold value, said electronic interruption unit goes to the high-impedance state and said mechanical isolating contact is opened.

28. The circuit breaker device according to claim 18, wherein the circuit breaker device is configured such that said contacts of said mechanical isolating contact can be opened, but not closed, by said controller.

29. The circuit breaker device according to claim 18, further comprising a differential current sensor for ascertaining differential currents in the electrical low-voltage circuit.

30. The circuit breaker device according to claim 18, wherein the circuit breaker device is configured such that position information relating to said contacts is ascertained, and is transmitted to said controller.

31. The circuit breaker device according to claim 18, wherein the checking function contains a self-test of a functionality of the circuit breaker device, during which a plurality of components of a plurality of units, of the circuit breaker device are checked, and if at least one component of the plurality of components, of the plurality of units, is functional, the low-impedance state is allowed.

32. The circuit breaker device according to claim 18, wherein:
in a case of a connected said mechanical isolating contact and said electronic interruption unit has the low-impedance state, and:
in a case of an ascertained current exceeding a first current threshold value for a first period of time, said electronic interruption unit goes to the high-impedance state and said mechanical isolating contact remains closed;
in a case of the ascertained current exceeding a second current threshold value for a second period of time, said electronic interruption unit goes to the high-impedance state and said mechanical isolating contact is opened; and
in a case of the ascertained current exceeding a third current threshold value, said electronic interruption unit goes to the high-impedance state and said mechanical isolating contact is opened.

33. The circuit breaker device according to claim 24, wherein the checking function carries out a check of all of the parameters continuously, and if a respective one of the parameters is no longer exceeded or undershot, a low-impedance state of said semiconductor-based switching elements is allowed, if said contacts were not opened.

34. A method for a circuit breaker device for protecting an electrical low-voltage circuit, which comprises the steps of:
ascertaining a level of a current of the electrical low-voltage circuit;
operating a mechanical isolating contact using a mechanical handle, with a result that opening of contacts to prevent a current flow or closing of the contacts for the current flow in the electrical low-voltage circuit can be switched;
setting an impedance of an electronic interruption unit which is connected in series with the mechanical isolating contact on a circuit side and which, as a result of semiconductor-based switching elements, has a high-impedance state of the semiconductor-based switching elements in order to prevent the current flow and a low-impedance state of the semiconductor-based switching elements for the current flow in the electrical low-voltage circuit;
comparing an ascertained level of the current with current and/or current-time limit values and if the current and/or current-time limit values are exceeded a process for preventing the current flow in the electric low-voltage circuit is initiated; and
operating, via a user of the circuit breaker device, the mechanical handle in order to close the contacts, wherein the electronic interruption unit initially in the high-impedance state, and that, after the contacts have been closed, the electronic interruption unit goes to the low-impedance state only if a checking function allows the low-impedance state of the semiconductor-based switching elements.

35. A non-transitory computer program comprising computer executable instructions for carrying out the method according to claim 34.

36. A non-transitory computer-readable storage medium having computer executable instructions for performing the method according to claim 34.
